(19) United States
(12) Patent Application Publication
(10) Pub. No.: US 2019/0094186 A1
(43) Pub. Date: Mar. 28, 2019

(54) IMMERSIBLE ULTRASONIC PROBE FOR NONDESTRUCTIVE EXAMINATION AND IMAGING IN HARSH AND HIGH TEMPERATURE MEDIA AND METHOD OF MAKING

(71) Applicant: BATTELLE MEMORIAL INSTITUTE, Richland, WA (US)

(72) Inventors: Aaron A. Diaz, Richland, WA (US); Michael R. Larche, Pasco, WA (US); Royce A. Mathews, Kennewick, WA (US); Gerald J. Posakony, Seattle, WA (US)

(73) Assignee: BATTELLE MEMORIAL INSTITUTE, Richland, WA (US)

(21) Appl. No.: 15/719,334

(22) Filed: Sep. 28, 2017

(51) Int. Cl. G01N 29/24; G01N 29/04

(52) U.S. Cl. CPC G01N 29/2437; G01N 2291/0258; G01N 29/04

(57) ABSTRACT

Immersible ultrasonic probes and methods of making are disclosed that provide nondestructive examination, imaging, and assessment of submerged targets in various liquid media including corrosive and optically opaque media at harsh conditions. In one embodiment the probe is a phased-array ultrasonic testing probe that includes an array of piezoelectric elements configured to transmit ultrasonic signals at selected frequencies through an opaque medium that enables nondestructive examination, characterization, and imaging of targets in the opaque medium.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### FIELD OF THE DISCLOSURE

The present disclosure relates generally to ultrasonic inspection probes and nondestructive examination approaches.

### BACKGROUND

Ultrasonic testing probes and transducers are important tools for nondestructive testing that utilize ultrasonic waves to detect flaws such as corrosion in various structures where conventional optical based approaches are ineffective such as in optically opaque materials and media such as liquid sodium as well as other harsh or otherwise difficult conditions such as in high temperature caustic and corrosive environments that are also difficult to examine or evaluate. As one example, a need exists to re-establish domestic technology infrastructures to support deployment of sodium-cooled fast reactors. Development of ultrasonic devices capable of viewing structures in liquid sodium could enable nondestructive examination and imaging of critical structural systems and components submerged in the liquid sodium within the reactor and allow operations in this optically opaque and highly corrosive medium at high temperature conditions to be monitored. For example, In-service Inspection and Repair (ISI&R) systems and approaches must be developed that have a capability to interrogate (probe) selected targets including structures and components in optically opaque media such as liquid sodium or other harsh liquid media such as corrosives, caustics, and petrochemicals or other chemical media at elevated or high operational temperatures (˜260° C.) to support effective operations and maintenance activities as well as to reliably examine integrity and safety of structures and components submerged in these media at these elevated temperatures or to collect baseline data for reconstructing images of these submerged targets and structures. In addition, these systems must be robust so as to operate successfully and have useful lifetimes when immersed in these opaque materials at these extreme conditions, The present invention represents a substantial step forward in addressing these needs. Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present disclosure describes new immersible phased-array ultrasonic testing (UT) probe devices and methods for nondestructive examination (NDE) and imaging of submerged targets in various selected media such as corrosive, optically opaque media at high temperatures including liquid sodium, oil, petroleum fuels and petrochemicals, and other caustic and corrosive media that are not provided for by systems and approaches in the prior art. Data acquired with these immersible probes can allow images of submerged targets to be reconstructed; physical and rheological properties of these media to be measured; process monitoring; detection of flaws, cracks and other degradation mechanisms in structures and components; operational effectiveness of targets in these media to be assessed and validated; and applications in these media to be controlled. In one embodiment, an immersible ultrasonic inspection device for NDE of submerged targets in corrosive, optically opaque media is described having an immersible housing assembly that includes a first housing member or assembly and a second housing member. In some applications the second housing member can include a metal different from the metal of the first housing member. In one example, the first housing member can be comprised of a metal such as nickel alloy 200 and the second housing member can be comprised of a metal such as a steel alloy. In one embodiment, the first housing member can include a metal faceplate comprised of nickel alloy 200 or another suitable metal. The first housing member and second housing member can be welded together to form the immersible housing assembly. These immersible probes can include a transducer element having one or more arrays such as matrix phased arrays comprised of multiple individual piezoelectric transducer elements each comprised of a piezoelectric material. In various embodiments, piezoelectric elements can be comprised of selected titanates including Lead Zirconate Titanate (PZT); bismuth titanate; and barium titanate. In some embodiments, the transducer element can comprise individual piezoelectric elements configured as a one-dimensional (1D) linear phased array of piezoelectric elements of a pulse-echo design, for example, wherein the array of piezoelectric elements both transmits a suitable sound field into the selected medium and receives resultant pulse echoes from the medium. In some embodiments, the transducer element can comprise individual piezoelectric elements configured as two-dimensional (2D) matrix phased arrays of a transmit-receive matrix design in which the transmit and receive arrays are physically isolated. One array of transducer elements can be configured to transmit a sound field into the selected medium and one array of transducer elements can be configured to receive resultant echoes from the medium.

Individual piezoelectric transducer elements can be bonded to a inside rear surface of the metal transducer faceplate within the first housing assembly utilizing a metal bonding material such as a silver metal solder. Individual transducer elements in the array can be electrically connected to an excitation element such as a magnet-type copper wire that enables piezoelectric elements in the array to be energized individually or collectively. The connecting step can include tinning ends of the excitation wires and then soldering ends of the excitation wires to the individual piezoelectric elements in the array. The transducer device is configured to transmit an ultrasonic signal that interrogates structures, components, or submerged targets within a medium and to collect ultrasonic signals returned from the structures, components, or submerged targets for NDE and imaging thereof.

In one exemplary approach, fabrication of the immersible ultrasonic probe for NDE and inspection and imaging includes the steps of: coating the piezoelectric material utilized in the piezoelectric transducer device with a thin metal coating that acoustically matches the metal of the rear surface of the ultrasonic transducer faceplate in the first or second housing member. The coating can be comprised of an electrode metal such as a nickel alloy (e.g., nickel alloy-200) or another suitable material. In another exemplary step, an array of individual piezoelectric elements of various dimensions and channel widths can be formed in the metal-coated piezoelectric material by methods such as laser etching or cutting. Piezoelectric element arrays can be bonded to the rear surface of the ultrasonic transducer faceplate utilizing a metal containing bonding material such as a silver-containing solder or silver-containing foil or other suitable metal to form a metallic interface between the rear surface of the faceplate and the transducer device. The bonded metal containing material forms a metallic interface that includes a suitable coefficient of thermal expansion and a suitable acoustic impedance so as to be both thermally and/or acoustically matched to the individual piezoelectric transducer elements and the metal of the transducer faceplate. This thermal and acoustic matching prevents cracks in the metallic interface from taking place to prevent individual piezoelectric elements in the phased arrays from decoupling, and to ensure that effective transmission of acoustic energy into the medium takes place while at sustained high temperature operation conditions. Another step can include attaching individual excitation wires such as copper magnet-type excitation wires to individual piezoelectric elements in the transducer arrays that enable delivery of excitation pulses to the individual piezoelectric elements in operation. The first housing and second housing assemblies can then be welded together such as by seal welding to form a fluid-tight seal weld between the housing members. The seal welded housing members form the immersible housing assembly that enables the immersible probe to be immersed in the selected medium. In operation, these immersible probes can be utilized to actively interrogate structures and submerged targets or other components to determine the presence and location of flaws, damage, alignment problems or misorientation, and/or other structural changes.

In one exemplary approach, for example, the ultrasonic probe having a transducer device comprised of an array of piezoelectric elements bonded to a metal faceplate within the immersible housing assembly (using a high temperature metal solder or foil forming an acoustically matched metal interface therebetween) can be immersed into the selected medium. Then, an ultrasonic signal or signals from the transducer device can be delivered (transmitted) through the metal faceplate at preselected frequencies to acoustically interrogate submerged targets in the selected medium. The transducer can then collect ultrasonic signals reflected from the submerged targets to provide nondestructive examination and imaging of the submerged targets in the selected medium. For example, phased arrays in the transducer device can permit boundaries and other discontinuities from acquired ultrasonic signals to be detected where reflection of incident wavefronts from target surfaces can then be utilized to identify and assess damage at, and beneath, surfaces of structures, components, or submerged targets. In one approach, for example, phased arrays can act as directional beam-steering devices that in concert with a selected wave propagation approach can actively probe target surfaces in different directions and at various insonification angles enabling damage on, or in, the targets to be identified. Further, ability to immerse these probes in harsh, corrosive, and/or high temperature media without damaging the piezoelectric transducer elements or affecting signal fidelity in these probes enables NDE and ultrasonic imaging of submerged targets in harsh media and environments such as in liquid sodium to be performed that are not provided by devices, systems and approaches in the prior art. Embodiments of the instant disclosure thus provide new capabilities that can be expected to find applications in various sectors including, for example, commercial nuclear and advanced nuclear reactor in-service inspections (ISIs), petrochemical, pharmaceutical, and other industries and sectors.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. Various advantages and novel features of the present invention are described herein and will become further readily apparent o those skilled in this art from the following detailed description. In the preceding and following descriptions preferred embodiments of the invention contemplated for carrying out the invention will be shown. As will be realized, the invention is capable of modification in various respects without departing from the invention. Accordingly, drawings and descriptions of preferred embodiments set forth hereafter are to be regarded as illustrative in nature and not as restrictive.

### BRIEF DESCRIPTION OF THE DRAWINGS

FIG. 1 is a perspective side view of one embodiment of the present disclosure.

FIGS. 2A-2C show different views of an exemplary housing assembly utilized in one embodiment of the present disclosure.

FIG. 3 shows a typical ultrasound test of an acoustically coupled metal interface.

FIG. 4 shows a cross-sectional view of an exemplary housing assembly utilized in one embodiment of the present disclosure.

FIGS. 5A-5B show digital ultrasonic images of submerged targets generated from acquired ultrasound data collected with one embodiment of the present disclosure.

### DETAILED DESCRIPTION

Immersible phased-array ultrasonic testing (PA-UT) probes for NDE and imaging of targets, structures, and components in harsh media including corrosive and optically opaque media at high-temperature and other extreme conditions and a method of making are detailed. The following description includes one implementation of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood that there is no intention to limit the invention to the specific form disclosed, but, on the contrary, the invention is to cover all modifications, alternative constructions, and equivalents falling within the spirit and scope of the invention as defined in the claims.

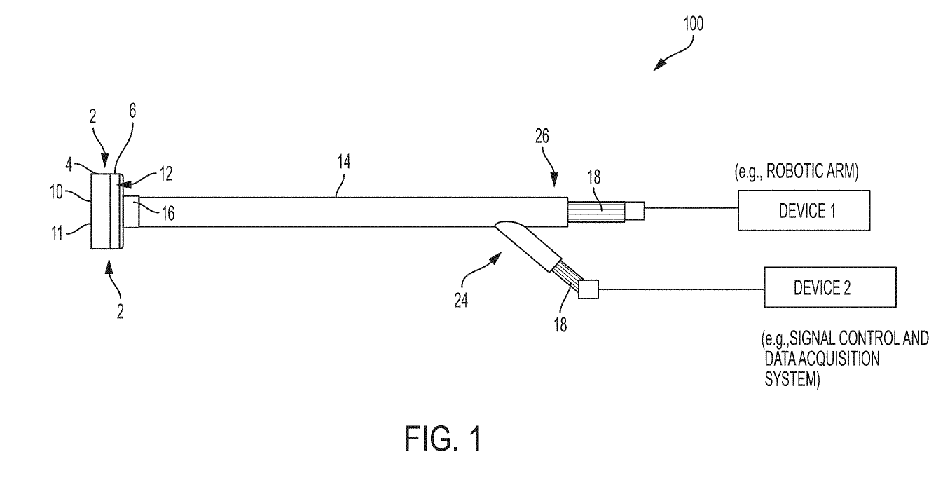

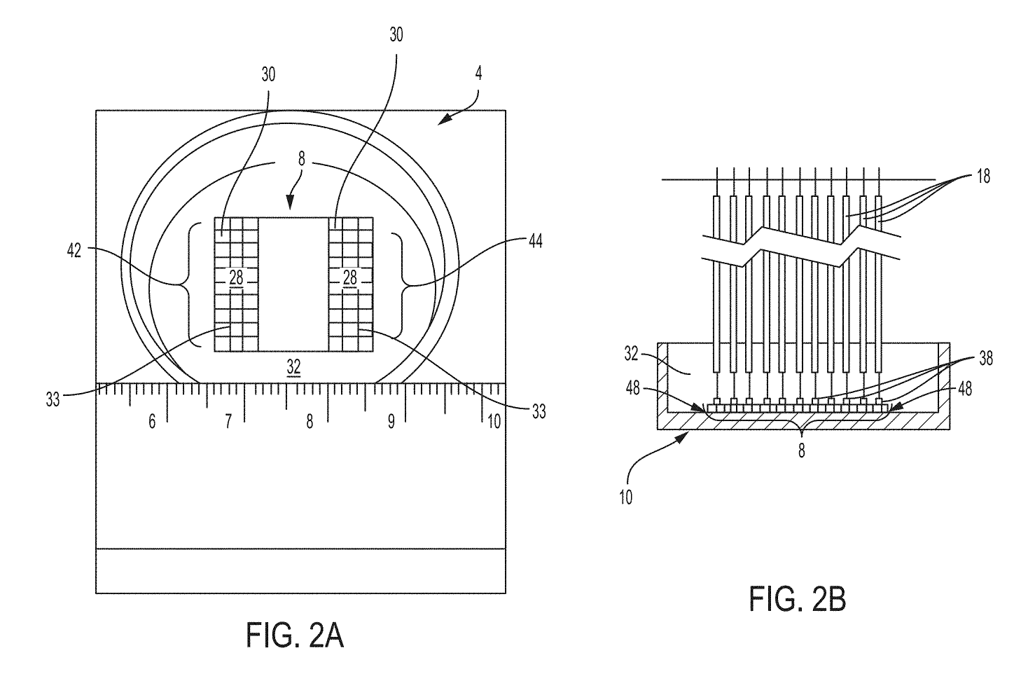

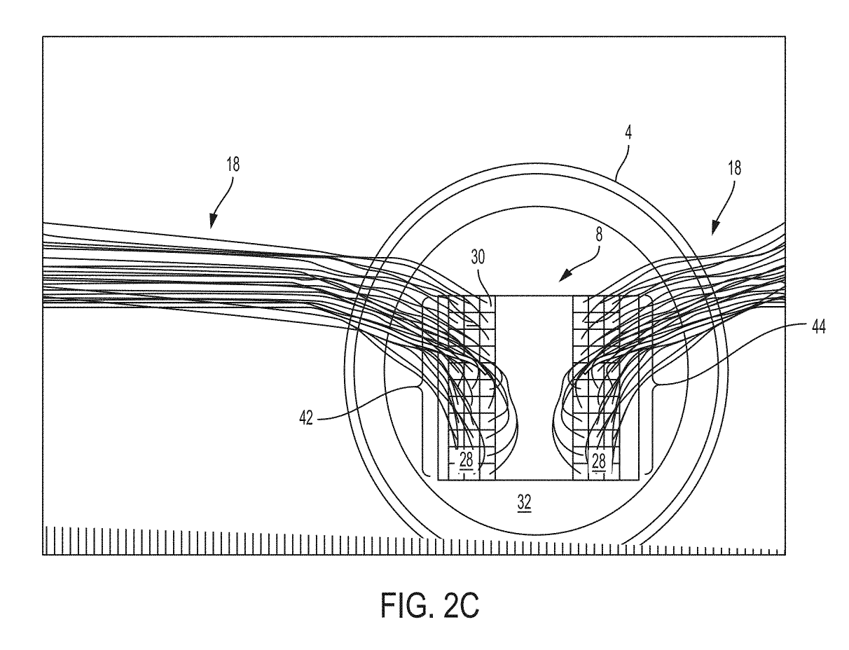

FIGS. 1-5 show different embodiments and aspects of the present disclosure. Referring first to FIG. 1, one embodiment of an immersible ultrasonic testing (UT) device 100 for nondestructive examination (NDE) of submerged targets in selected media including harsh media and conditions is shown. Probe 100 components are constructed of materials with physical properties including a high corrosion resistance, for example, that enable sustained operation when the probe 100 is immersed in harsh media at harsh conditions such as corrosive media and high temperature conditions, for example. Probe 100 includes an immersible housing assembly 2 comprised of a lower cup housing 4 and an upper cup housing 6. Immersible housing assembly 2 encloses a transducer element therein described further in reference to FIG. 2A. The transducer elements can be comprised of multiple individual piezoelectric (transducer) elements fabricated of a suitable piezoelectric material including titanates such as Lead Zirconate Titanate (PZT), bismuth titanate, barium titanate, for example, or another suitable piezoelectric material. The transducer element can be bonded to a rear surface of a front faceplate 10 in the lower cup housing 4. Components of the immersible housing assembly 2 can include various physical properties such as compatible thermal properties including a matching thermal expansion coefficient and/or acoustic properties such as a matching acoustic impedance with selected tolerances (e.g., ±10%), for example. Properties are not intended to be limited. For example, in the exemplary embodiment configured for examination of submerged targets in liquid sodium at high temperature, the lower cup housing assembly 4 and faceplate 10 can be comprised of a metal alloy such as a nickel alloy 200, for example. Upper cup housing assembly 6 can be comprised of a corrosion-resistant steel alloy such as a 316 stainless steel. Lower cup 4 and upper cup 6 assemblies can be welded together to form a secure seal weld 12 utilizing a seal-weld material such as a stainless-316-to-nickel-200 seal-weld material, for example, or other materials suitable for welding dissimilar metals together. Seal weld 12 prevents fluids from the target medium from breaching the immersible housing assembly 2 when the probe 100 is immersed therein that could damage, or result in decoupling of, individual piezoelectric elements of the transducer element therein.

Probe 100 can also include a probe shaft 14 of any suitable or selected length with an end that inserts into a securing device 16 such as an adapter ring 16, for example, positioned at the top of the upper cup housing 6 assembly. Probe shaft 14 can be secured by welding the attachment end in the adapter ring 16 utilizing a high-temperature compatible metal welding material such as a silver-containing solder, for example. Probe shaft 14 encloses excitation wires 18 therein extending from the top of the upper cup housing 6. These excitation wires 18 are electrically coupled to the transducer element within the immersible housing assembly 2. Excitation wires 18 extending from the transducer 8 elements 30 into the probe shaft 14 are each insulated in high temperature compatible thermal insulation (not shown) to prevent electrical shorting and to minimize signal cross-talk between the excitation wires 18 and to provide efficient conduction of voltages over a wide range of temperatures while the probe 100 is immersed in the target medium. Excitation wires 18 extending from the top end of the probe shaft 14 can be electrically connected via connectors such as multiple-wire connectors and PA-UT connector cables to various devices including, signal control and/or data acquisition systems that deliver selected voltages to individual piezoelectric elements; to raster scanning systems that enable probing of submerged targets in liquid media; to robotic arms that enable in-reactor nondestructive examination of targets; and other selected devices, for example. Excitation wires 18 may be coupled to these connectors, for example, utilizing a high-temperature metal solder such as a silver metal solder that can be utilized in concert with a metal flux. In some embodiments, the probe shaft 14 includes a branched end 24 and a straight end 26 with openings through which excitation wires 18 exiting the probe shaft 14 connect to these other control and examination devices. The branched arm 24 can be utilized, for example, to reduce strain at junctions between connectors and excitation wires 18 and devices to which these wires connect. The straight end 26 of the probe shaft 14 can be utilized when connection to devices along a linear axis may be needed or where little strain between connectors and excitation wires 18 is expected such as in raster scanning systems and robotic arms utilized for remote handling of these immersible probes 100 enabling NDE, assessment, and evaluation of submerged targets and/or other structures and components in full-scale reactors, for example, and elsewhere.

FIG. 2A shows a top view of lower cup housing 4 that includes a transducer element 8 attached to the inside surface 32 (also rear surface of faceplate 10, FIG. 1) within the lower cup housing 4. In the figure, lower cup housing 4 has a round shape but other shapes can also be utilized such as a rectangular shape. Rear surface 32 is machined to provide a smooth and uniform surface topology that enables transducer element 8 to be securely attached to surface 32. In some embodiments, transducer element 8 is comprised of a ceramic piezoelectric material such as lead zirconate titanate (e.g., PZT-5A4E) or bismuth titanate suitable for sustained high temperature operation and conditions. Transducer element 8 has a preferred uniformity tolerance of 0.001 mm (±10,000 Angstroms) across the un-etched surface of the transducer 8 that enables the transducer element 8 to transmit acoustic signals at proper frequencies and at suitable bandwidths. The piezoelectric material is preferably coated with a thin (˜0.0015 inch) layer 36 of an electro-less nickel metal plating material such as a nickel alloy; a nickel-phosphorous alloy (e.g., containing 2-10% phosphorous); or another suitable metal material before forming the individual piezoelectric elements 30 of the transducer 8 and before bonding the transducer element 8 into the lower cup housing 4. The plating material serves to acoustically match and couple the metal bonding interface 34 formed between the transducer element 8 and the metal surface 32 when the transducer element 8 is secured thereto in housing 4. Transducer element 8 can be secured to surface 32, for example, by bonding or welding the transducer element 8 to rear surface 32 utilizing a high temperature metal bonding material such as a high temperature silver solder or silver foil that forms a bonded metal interface 34 between transducer element 8 and rear surface 32 suitable for sustained high temperature operation. Metal interface 34 provides acoustic matching and prevents decoupling of individual piezoelectric elements 30 in the transducer element 8 from surface 32 during operation. In one example, the silver-containing solder is comprised of 5% tin (Sn), 93% lead (Pb), and 1.5% silver (Ag), for example. A silver-containing solder foil may also be utilized comprised of 1% (Sn), 97.5% (Pb) and 1.5% (Ag), for example.

In one exemplary approach, contact between the transducer element 8, the metal bonding material, and rear surface 32 during bonding can be maintained utilizing, for example, a weighted (e.g., a 3.5 pound) fixture (not shown) such as a graphite fixture that enables the transducer element 8 to be centered on surface 32 in the lower cup (e.g., 2 inch round Ni-200 alloy) housing 4. The weighted fixture and transducer element 8 positioned on rear surface 32 can then be heated at a temperature and time sufficient to form the bonded metal interface 34 between transducer 8 and rear surface 32 of faceplate 10. In one example, the weighted assembly was baked at a temperature ˜25° C. below the Curie temperature of the transducer 8 such as from about 300° C. to about 325° C. for a time of from about 1 to about 3 hours, for example. Processing temperatures and curing times will vary depending on the Curie temperature of the selected piezoelectric materials.

The bonded transducer 8 can be machined to form element arrays 28 containing selected quantities, numbers, arrangements, sizes, and spacings of individual piezoelectric transducer elements 30 by a suitable fabrication or processing method such as laser-etching, for example. In one exemplary approach, the laser etching process utilizes laser pulses of sufficiently short duration and energy to limit potential for temperature spikes in any one area of the transducer element 8 impacted by the laser beam to an area as few as three microns (3 μm) or less. Maximum temperatures are maintained preferably at least about 25° C. below the Curie temperature of the piezoelectric material to maintain the crystal structure of the piezoelectric material. In some embodiments the arrays 28 can be one-dimensional (1D) linear arrays of individual piezoelectric elements 30. In some embodiments the arrays 28 can be two-dimensional (2D) matrix phased arrays of individual piezoelectric elements 30. Number and arrangement of piezoelectric transducer elements 30 in each transducer array 28 are selected to provide ultrasonic signals with energy sufficient for propagation, and signal properties tuned, for imaging in the selected medium. In some embodiments, the transducer element 8 can include both a signal transmission block 42 of individual piezoelectric elements 30 and a separate and physically isolated signal collection block 44 of piezoelectric elements 30 as shown in FIG. 2A. In some embodiments, the transducer element 8 is comprised of individual piezoelectric elements 30 that perform both signal transmission and signal collection in separate operation modes. Individual elements 30 in etched blocks 42, 44, and 46 can be physically separated from other piezoelectric elements 30 in the various block by etching channels 33 of a selected depth between the piezoelectric elements 30. Piezoelectric elements 30 of the transducer element 8 are preferably attached to a fused base portion 48 as shown in FIG. 2B. A typical etch-to-fused ratio is about 90% etched and 10% fused.

Individual transducer elements 30 in the transducer arrays 28 can each bonded to an individual excitation wire 18, as shown. Excitation wires 18 are preferably high temperature compatible wire such as insulated magnet-type NEMA MW16-C 30 gauge copper wires or another suitable wire that enable sustained operation at high temperature (e.g., 240° C. rated) conditions. Typically, ends of each insulated copper wire are stripped (˜1-2 mm), tinned, and then soldered, for example, to the top of individual piezoelectric elements 30 utilizing a high temperature compatible metal solder such as silver metal solder. In one exemplary approach, solder wire is utilized to form small solder point connections 38 between the excitation wires 18 at each individual piezoelectric element 30. Position of the solder point connection 38 on each piezoelectric element 30 is selected to provide an optimum excitation voltage through each piezoelectric element 30. In some embodiments, longer piezoelectric elements 30 are utilized such as in 1D linear arrays. The solder point connection 38 can be positioned at any location along the length of the individual piezoelectric elements 30 as excitation voltage is not generally affected by position of the soldering point 38 in these elements 30, in some embodiments, shorter piezoelectric elements 30 are utilized such as in 2D matrix arrays 28 with the solder point 38 positioned at or near the center of the piezoelectric elements 30. FIG. 2C shows the assembled components of lower cup housing assembly 4.

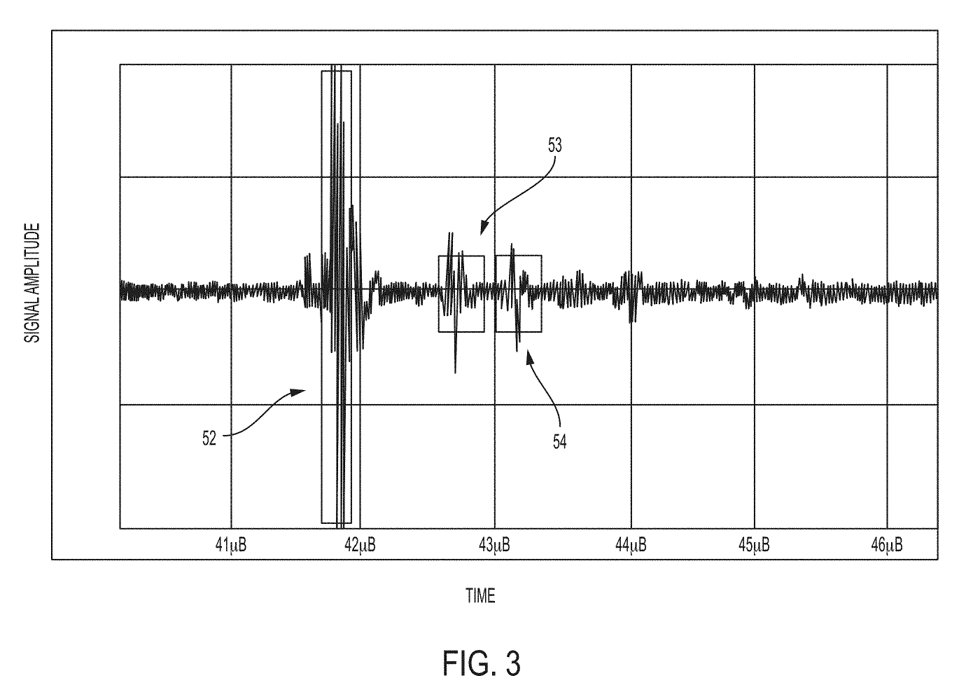

Effective acoustic coupling is one attribute for obtaining efficient acoustic transmission of ultrasonic energy in the selected target medium. High-frequency acoustic methods can be utilized to assess physical properties and acoustic characteristics of the bonded metal material that forms the metal interface 34 and to acquire metrics for evaluating the acoustic coupling. For example, the bonded metal material that forms the metal interface 34 between transducer element 8 and rear surface 32 in the lower cup 4 assembly can be acoustically tested to ensure the metal interface 34 is acoustically coupled and matched and that any discontinuities such as air gaps in the interface 34 between rear surface 32 and transducer element 8 are insignificant so as to prevent debonding of the metal material that forms the interface 34 or decoupling individual piezoelectric elements 30 in the transducer 8 during sustained high temperature operation. The selected acoustic testing approach measures the fraction of sound energy transmitted through and reflected by various boundaries within various multi-layered structures including the transducer element 8, the bonded metal interface 34, and the transducer faceplate 10, for example, as the signal traverses these structures into the target medium. This approach allows the entire surface of the metal interface 34 to be mapped to ensure transmission and reflection of acoustic signals are optimized in reference to an established noise threshold, for example. In one exemplary approach to acoustic testing, an acoustic microscope can be positioned immediately above the lower cup 4 and a high frequency signal from the test transducer can be transmitted toward the front surface of the probe. Acoustic signals can then be recorded at various material transitions including the transducer faceplate 10, at the metal interface 34 between the rear surface 32 and the transducer element 8, and at a back end of the transducer element 8 in the lower cup housing assembly 4. FIG. 3 shows results from a typical acoustic signal transmission test at a single test location in the metal interface 34. In the figure, a large signal 52 was obtained at the front surface of the faceplate 10, a small reflection signal 53 was obtained at the metal interface 34 between the rear surface 32 and the transducer element 8, and a second small signal 54 was obtained at a back end of the transducer element 8 in the lower cup housing assembly 4 where sound can be delivered if transmitted properly. In this mode of testing, height of signal 53 from the bonded metal interface 34 is preferably below about 25% of screen height, meaning ultrasonic signal response amplitudes are at least about 85% or better. Acoustic coupling efficiency is also be selected to ensure a substantial fraction of the ultrasonic signal generated by the transducer 8 is transmitted into the target medium for interrogation of submerged targets, structures, and components, for example. Efficiencies are preferably above 80%, more preferably above 85%, and even above 90% if achievable. Test results show the metal bonded interface 34 between the transmission faceplate 10 and the transducer element 8 in the lower cup housing assembly 4 is acoustically coupled and that acoustic coupling efficiency is above 90% ensuring a nearly quantitative fraction of the ultrasonic signal generated by the transducer 8 is transmitted into the target medium with each pulse.

In operation, transducer 8 elements 30 can be individually or collectively energized to create various focal spot sizes and sound field depths during transmission of ultrasonic pulses from the transducer 8. For example, in embodiments where the transducer element 8 includes both a signal transmission block 42 of individual piezoelectric elements 30 and a signal collection block 44 of piezoelectric elements 30, transmission block 42 can be configured to transmit ultrasonic signals through the front faceplate 10 for interrogation of submerged targets. Sonic energy needed for interrogation of submerged targets in selected media is at least partially a function of the size (area) of the transducer element 8 and the individual piezoelectric elements 30 therein that provide sufficient sonic energy to effectively propagate the sonic interrogation beam into and through the selected medium and to provide sufficient penetration at selected depths in the medium at a suitable signal-to-noise ratio (SNR). Collection block 44 can be configured to collect ultrasound signals reflected from these submerged targets in the medium through the front transducer faceplate 10 for subsequent analysis. In embodiments where the transducer element 8 is comprised of a single block 46 of individual piezoelectric elements 30 that performs both signal transmission and signal collection in separate operational modes, piezoelectric elements 30 can be configured to transmit ultrasonic signals through the front faceplate 10 for interrogation of submerged targets and then to collect ultrasound signals reflected from these submerged targets in the medium through the front faceplate 10 for subsequent analysis.

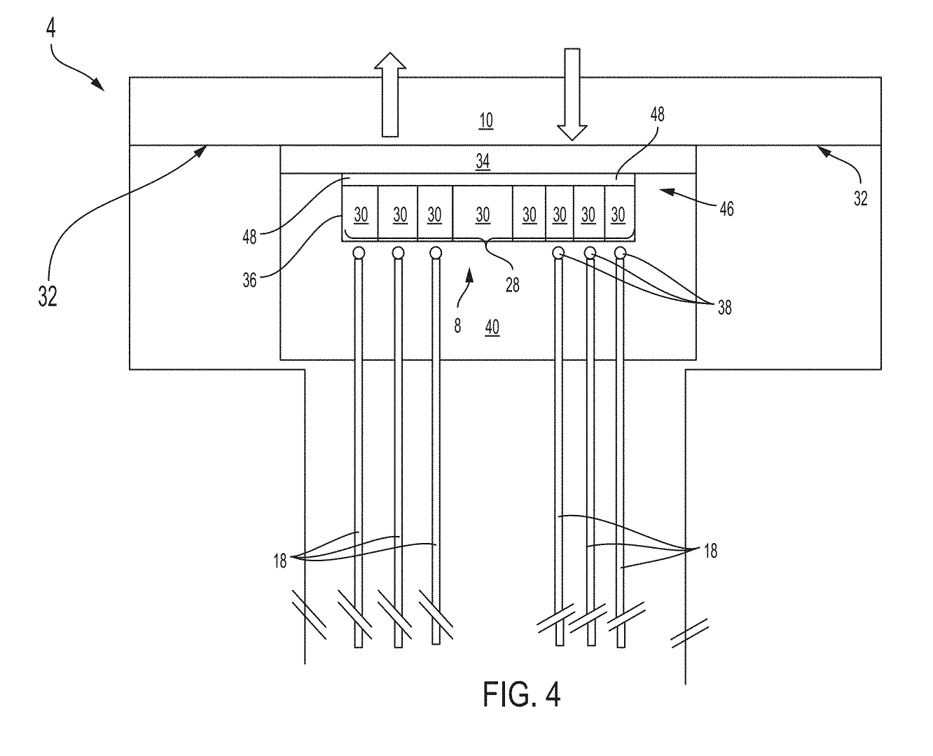

As shown in FIG. 4, phased arrays 28 with individual piezoelectric elements 30 each attached to an energizing wire 18 by solder point connections 38 are preferably encased in an acoustic backing material 40 to a selected depth. In one example, the backing material 40 was a high temperature (rated to 1315° C., 2600° F.) ceramic adhesive such as RESBOND™ (model 940 ceramic adhesive) that was mixed with a liquid activator e.g., model 940LE) in a ratio of 100 parts base powder to 45-50 parts activator by weight, for example. Depth of the backing material 40 depends at least in part on the dimensions of the cup housing 4. Typical depths range from about 6 mm to about 7 mm or more. During signal transmission from the piezoelectric elements 30, backing material 40 dampens sound reverberations within the immersible housing assembly 2 that prevents decoupling of individual element 30-to-wire-18 connections 38 during operation at extended high temperature conditions and enables a suitable operational bandwidth for the generated sound field. Damping acoustic reverberations enables broadband ultrasonic signals to be transmitted into the selected medium over a range of selected bandwidth frequencies. The excitation or driving frequency is selected to maximize energy during operation and efficiently drive the individual piezoelectric elements 30 at an optimal frequency. Operational frequencies selected for transmission depend in part on various factors including characteristics of the medium, target sizes in the medium, path length of the sound field, and others. Piezoelectric material dimensions and specifications can be selected to generate operational frequencies that match these determined characteristics.

The exposed surface (not shown) of faceplate 10 can be machined or polished to enable efficient acoustic coupling and wetting of the faceplate 10 for effective transmission of UT signals when the probe 100 is immersed in the selected target medium. Polishing can be performed utilizing various polishing tools (e.g., lap tools) and abrasives e.g., colloidal silica in a kerosene or distillate oil) and selected grit sizes including, for example, 6-micron diamond laps (e.g., ˜10 min) and 1-micron diamond laps (e.g., ˜5 min) and down to fine grit polish (e.g., 0.05 um grit size). Final polishing (˜5 min) of the front faceplate 10 surface is preferably performed in an inert gas environment to prevent surface oxides from forming on the front surface 11 of the faceplate 10 prior to immersing the probe 100 in the target medium. This final step can remove a typical quantity of the faceplate 10 or rear surface 32 metal of from about 0.002 in. (0.005 cm) to 0.003 in. (0.008 cm). Polished surfaces can then be rinsed (e.g., in ethanol) and dried. Polishing and cleaning of the front surface of faceplate 10 can be repeated as necessary following exposure to air or immersion in the target medium.

In operation, probe 100 transmits focused ultrasonic signals, for example, as ultrasound pulses from the transducer element 8 that are transmitted through the front transducer faceplate 10 that strike the surface of structures, components, and submerged targets, for example, resulting in reflected signals that are returned to, and collected by, the probe 100 that are subsequently utilized to generate a reconstructed image of these interrogated targets. Each signal can be propagated through the selected medium and the signal excitation and ring-down recorded. Elapsed time between transmission of a focused pulse and detection of the reflected signal provides a measure of the distance between the transducer 8 and the surface of the target. Various ultrasonic transmission approaches and sound propagation modes can be utilized to interrogate submerged targets as will be understood by those of ordinary skill in the art without limitation including longitudinal and shear wave modalities via immersion and contact implementations, respectively; raster-scanning in such modalities as pulse-echo and transmit-receive configurations, for example. In addition, various operational parameters can also be selected that enable detection, discrimination, and characterization of structures, components, and submerged targets of interest at high SNRs including, for example, excitation timing of each piezoelectric element 30; signal pulse rates; ultrasound interrogation frequencies and frequency bandwidths; and ultrasound signal intensities. In addition, sound field properties such as depths of field; focal spot sizes; and other sound properties such as sound beam steerability, skew angles, and minimum angular resolution thresholds can be selected. Image reconstruction can utilize various signal processing approaches to discriminate ultrasonic features from signal noise in acquired image data to obtain sufficient image resolution enabling detection, localization, and/or characterization of these structures, components, and submerged targets. Signals can be characterized utilizing such functions and methods as best linear estimator functions and methods; sparse representation and dictionary learning functions and methods; and k-nearest neighbor functions and methods. Signal processing can also include various filtering approaches such as bandpass filtering; signal subtraction such as time-domain noise subtraction and generalized linear transformation subtraction such as Moore-Penrose inverse subtraction, for example. In some applications specific signal processing algorithms such as point-spread functions and three-dimensional (3D) deconvolution approaches can be utilized. Signal processing can further include time gating, signal averaging, analytical signal magnitude processing, data smoothing such as cubic spline smoothing, and machine learning such as deep neural net learning and various combinations of these signal processing approaches and others as will be implemented by those of ordinary skill in the art.

### EXAMPLE 1

Probes configured with various piezoelectric element arrays were utilized to perform interrogation tests of submerged targets in various media including water at room temperature, hot oil at 260° C., and liquid sodium. Probes were submerged in a test tank below the liquid fill level at various standoff distances to acquire signal data from interrogated targets. The probe faceplate and piezoelectric element arrays were oriented towards the bottom of the tank during data collection. Targets were positioned at typical depths from about 50 mm to 100 mm. Parameters such as focal depth, refracted angle, spot size, and depth of field were selected for the probes to create sound field properties delivered into the target medium. TABLE 1 lists the piezoelectric element configurations and sound field characteristics utilized for these probe tests. Three sets of parameters are listed for each probe array.

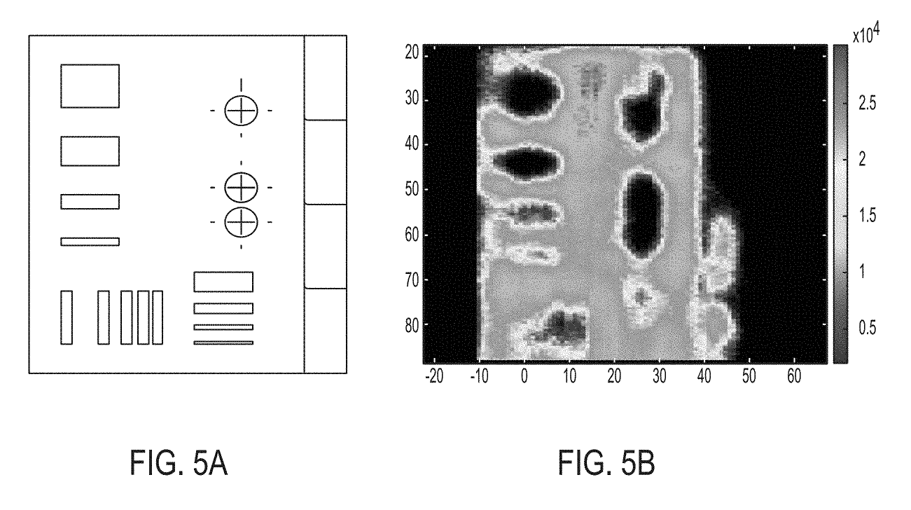

Probes were operated utilizing longitudinal-wave pulse-echo signal transmission. In one typical and exemplary mode of interrogation, the area containing the submerged target was raster scanned utilizing an X-Y raster scanning modality generating a series of subdivided image scan lines or segments which contain ultrasonic data reflected and returned from the target that were collected by the probe. Data were collected and stored for subsequent signal processing and imaging enabling subsequent generation of a 3D reconstructed image of the submerged targets. Time gating produced a number of lower amplitude shadow responses that were different from the reflected echo responses obtained from the submerged targets. A post-processing subtraction algorithm was also applied to the raw ultrasonic data to improve image quality. FIG. 5A is a line drawing showing one set of exemplary targets utilized within the test reactor having various shapes, sizes, and dimensions submerged in liquid sodium. FIG. 5B shows a reconstructed grey-scale image of these submerged targets. A range of incident angles was applied and target features were insonified. Return signals were captured and analyzed both individually and in a merged data set. In pulse-echo mode, time-gated windows were applied, for example, and various approaches utilized to detect target features. Starting clockwise from the upper right (FIG. 5A), a single vertical pin is shown. The pin is clearly detected and shown in the ultrasonic image (FIG. 5B). Directly below the single pin is a pair of vertical pins, which are clearly evident in the reconstructed image. To the right of these vertical pins is a series of four steps spaced 1 mm apart. The time-gated reconstructed image shows the two highest steps in the test reactor at the lower right of the reconstructed image. At the bottom, the reconstructed image shows small amplitude responses obtained from a series of both horizontally oriented notches and vertically oriented notches. Finally, at the left side of the image, a series of four horizontally oriented pins is shown. The smallest diameter pin is positioned at the lower left and the largest diameter pin is shown on the upper left of the image. The reconstructed image shows that all three of the vertical pins and all four of the horizontal pins were clearly detected. Larger notches and step reflectors were also detected. In general, results show the raster scan data acquisition modality provided good imaging and detection results. More advanced image reconstruction techniques can be applied to further optimize and enhance these results.

Probes of the present invention are immersible interrogation probes that are expected to provide nondestructive examination of various structures and components, and submerged targets in harsh liquid media including corrosive and high temperature and optically opaque media such as liquid sodium and otherwise difficult liquid media and materials including caustic and corrosive materials and environments such as petroleum products that cannot be examined with ultrasonic examination systems, devices, and approaches taught in the prior art. Other media and materials are also envisioned. Probes of the present invention are also expected to enable measurement of various physical properties including rheological parameters in these media to enhance process monitoring and control applications in such media that as well as data and information for future development and engineering of various and related product lines for uses in the petrochemical industry, pharmaceutical industry, commercial nuclear ISI, advanced nuclear reactor technology, and other sectors.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. An immersible ultrasonic device for nondestructive examination of submerged targets, comprising:
an immersible housing assembly comprising a first and second housing member with a fluid-tight seal weld therebetween enclosing a transducer device comprising an array of piezoelectric elements therein configured to generate and transmit ultrasonic signals from the immersible housing assembly to interrogate targets submerged in a selected medium.

2. The device of claim 1 wherein the first and second housing member are comprised of a metal or metal alloy different from the other.

3. The device of claim 1 wherein the first housing member includes a metal transducer faceplate with the transducer bonded to a rear surface thereof with an acoustically matching metal interface bonded therebetween.

4. The device of claim 1 wherein the piezoelectric elements are comprised of lead zirconate titanate or bismuth titanate.

5. The device of claim 1 wherein the array is a 1D array of piezoelectric elements configured to transmit ultrasonic signals into the medium and to receive resulting echoes from the medium.

6. The device of claim 1 wherein the array is a 2D matrix array of piezoelectric elements comprising a signal transmission block of piezoelectric elements and a signal collection block of piezoelectric elements each block of piezoelectric elements physically separated from the other block of piezoelectric elements attached to a fused base portion.

7. The device of claim 1 wherein the transducer is surrounded by a composite backing material comprising a ceramic adhesive and an epoxy polymer.

8. The device of claim 1 wherein the piezoelectric elements are each electrically connected to an excitation wire using a metal containing solder.

9. The device of claim 8 further including a metal shaft device of a selected length coupled to the immersible housing assembly configured to enclose the excitation wires extending from the piezoelectric elements within the immersible housing assembly in high temperature thermal insulation therein.

10. A method of fabricating an immersible ultrasonic inspection device for nondestructive examination of submerged targets in selected media, comprising the step of:
forming an immersible housing assembly comprising enclosing a transducer device comprising an array of piezoelectric elements therein between a first housing member and a second housing member and welding the first and second housing member together to form a fluid tight seal therebetween;
wherein the transducer is configured to generate and transmit ultrasonic signals from the immersible housing assembly to interrogate submerged targets in a selected medium.

11. The method of claim 10 wherein the first and second housing member each comprise a metal or metal alloy different from the other.

12. The method of claim 10 wherein the piezoelectric elements are comprised of lead zirconate titanate, bismuth titanate, or another titanate.

13. The method of claim 10 wherein the transducer device includes a 1D array of piezoelectric elements configured to transmit ultrasonic signals into the medium and to receive resulting echoes from the medium.

14. The method of claim 10 wherein the transducer device includes a 2D matrix array of piezoelectric elements, wherein one block of piezoelectric elements is configured to transmit ultrasonic signals into the medium and one block of piezoelectric elements is configured to receive resulting echoes from the medium.

15. The method of claim 10 wherein the forming step includes surrounding the transducer device within a composite backing material comprising a ceramic adhesive and an epoxy polymer to provide acoustic damping therein.

16. The method of claim 10 wherein the forming step includes bonding the transducer to a metal faceplate in the first housing member using a metal bonding material comprising a high temperature silver solder or high temperature silver foil to form an acoustically matching metal interface therebetween.

17. The method of claim 10 wherein the forming step includes electrically connecting each piezoelectric element to an excitation wire using a metal containing solder configured to deliver an excitation pulse thereto.

18. The method of claim 10 further including attaching a metal shaft device of a selected length to the immersible housing assembly to enclose the excitation wires extending from the piezoelectric elements in the immersible housing in high temperature thermal insulation therein.

19. A method of non-destructive examination of submerged targets in selected media, comprising the step of:
submerging a ultrasonic probe into a selected medium comprising a transducer device comprising an array of piezoelectric elements bonded to a metal faceplate within an immersible housing assembly using a high temperature metal solder or foil defining an acoustically matched metal interface therebetween; and
delivering an ultrasonic signal from the transducer device through the metal faceplate to interrogate submerged targets in the selected medium.

20. The method of claim 19, wherein the medium is an optically opaque medium.
